(19) United States
(12) Patent Application Publication
(10) Pub. No.: US 2009/0293560 A1
(43) Pub. Date: Dec. 3, 2009

(54) ELECTRONIC DEVICE HAVING ANTI-THEFT FEATURE AND METHOD OF PREVENTING ELECTRONIC DEVICE FROM BEING STOLEN

(75) Inventor: Yasuyuki Ikeguchi, Itami City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/471,849

(22) Filed: May 26, 2009

(30) Foreign Application Priority Data
May 27, 2008 (JP) 2008-138017

(51) Int. Cl. E05B 65/00; E05B 15/00

(52) U.S. Cl. 70/262; 70/266

(57) ABSTRACT

An electronic device is provided with a first lock release code store memory including a first lock release code; a lock release flag store memory including a lock release flag that shows whether or not a lock is released; a comparison portion comparing the first lock release code with a second lock release code input by an input device; a control portion releasing, when the comparison by the comparison portion results in agreement, the lock to permit the electronic device to operate normally; and a determination portion determining whether or not the lock release flag store memory is authentic.

This nonprovisional application claims priority under 35 U.S.C. § 119(a) on Patent Application No. 2008-138017 filed in Japan on May 27, 2008, the entire contents of which are hereby incorporated by reference.

### BACKGROUND OF THE INVENTION

1. Field of the Invention

The present invention relates to an electronic device having an anti-theft feature and a method of preventing an electronic device from being stolen.

2. Description of Related Art

One typical method to prevent an electronic device from being stolen is generally to embed a sensor called a sensor tag in a product or attach a sensor tag to a cardboard box in which products are packaged, to further install a detection sensor on the door of a store and to sound an alarm when the product is carried away from the store without the feature of the sensor tag being inactivated by a register device. However, once a sensor tag is removed from a product, its effects are lost, with the result that no alarm is likely to be sounded even if the product is stolen. Hence, this method is unreliable.

A method for preventing a television set from being stolen is proposed. This method is to store, in the television set, contact information on a user and to notify, if the television set is found to be stolen, the user of information on the theft through a network.

An anti-theft method for use in a vehicle is proposed. In this method, once a vehicle is set in a caution state, electrical components in the vehicle enter a state in which they cannot operate normally. Thus, unless the electrical components are released from such a state in some way, they remain in the state in which they cannot operate normally. One way to release the electrical components in the vehicle from the state in which they cannot operate normally is to make a unique signal stored in an anti-theft device in the vehicle agree with a unique signal stored in a separately provided memory and to thereby release it.

Moreover, an invention is proposed according to which a radio receiver or a television set cannot be used as a result of reception signals being blocked or noise being produced unless permission to use them is given.

However, with any one of the conventional technologies described above, it is impossible to sufficiently prevent an electronic device from being stolen from a store.

To overcome the foregoing disadvantage, as an electronic device that has the function of preventing theft from a store, an electronic device is devised that operates normally only if a first lock release code previously stored in a memory agrees with a second lock release code input from an input device. Since a normal purchaser can receive the proper second lock release code at a store or the like, the purchaser can use the electronic device without problems; since a person who does not purchase it in an authorized manner cannot input the proper second lock release code, they cannot operate it normally. Thus, the electronic device achieves anti-theft effects.

In terms of convenience, once the proper second lock release code is input, a flag (hereinafter also referred to as a “lock release flag”) for showing whether or not the lock is released is set to show that the lock is released, and thereafter it is not required to input the second lock release code. This is what the electronic device is normally intended to be designed to perform.

However, when a person who acquires a television set in an unauthorized manner focuses on what it is normally intended to be designed to perform, copies data including the lock release flag stored in a non-volatile memory in a television set that is purchased in an authorized manner and in which the lock is released and writes the copied data in a non-volatile memory in the television set that is acquired in an unauthorized manner and in which the lock is not released, the television set acquired in an unauthorized manner can be operated normally.

### SUMMARY OF THE INVENTION

An object of present invention is to provide an electronic device that has the function of preventing data including a lock release flag from being so copied as to release a lock illegally and that thus achieves excellent anti-theft effects, and is also to provide a method of preventing an electronic device from being stolen.

To achieve the above object, according to one aspect of the present invention, there is provided an electronic device including: a first lock release code store memory including a first lock release code; a lock release flag store memory including a lock release flag that shows whether or not a lock is released; a comparison portion comparing the first lock release code with a second lock release code input by an input device; a control portion releasing, when the comparison by the comparison portion results in agreement, the lock to permit the electronic device to operate normally; and a determination portion determining whether or not the lock release flag store memory is authentic. The first lock release code store memory and the lock release flag store memory may be identical, each being a single memory.

To achieve the above object, according to another aspect of the invention, there is provided a method of preventing an electronic device from being stolen, the method including the steps of: storing a lock release code in a lock release code store memory included in the electronic device; producing information corresponding to the lock release code; making the electronic device request input of the information corresponding to the lock release code; comparing the input information with the lock release code stored in the lock release code store memory; making, when the input information is found to agree with the lock release code stored in the lock release code store memory, a lock release flag that is stored in a lock release flag store memory in the electronic device and that shows whether or not a lock is released show that the lock is released, and thus permitting the electronic device to operate normally; and determining whether or not the lock release flag memory is authentic.

According to the present invention, since the authenticity of the lock release flag store memory is determined, the function of preventing the following act is provided: a person who acquires a television set in an unauthorized manner copies data including a lock release flag stored in a lock release flag store memory in a television set that is purchased in an authorized manner and in which the lock is released, writes the copied data in a lock release flag store memory in the television set that is acquired in an unauthorized manner and in which the lock is not released and thereby makes the television set acquired in an unauthorized manner operate normally. In this way, the television set of the invention can achieve excellent anti-theft effects.

### BRIEF DESCRIPTION OF THE DRAWINGS

FIG. 1 a block diagram of a television set according to an embodiment of the present invention;

FIG. 2 is a diagram showing part of the manufacturing process of the television set shown in FIG. 1;

FIG. 3 is a diagram showing a procedure for issuing information corresponding to a lock release code;

FIG. 4 is a diagram showing an example of a flow chart on how the television set shown in FIG. 1 is operated; and

FIG. 5 is a diagram showing an example of the screen of the television set that requests the input of the information corresponding to the lock release code.

### DETAILED DESCRIPTION OF PREFERRED EMBODIMENTS

An embodiment of the present invention will be described below with reference to the accompanying drawings.

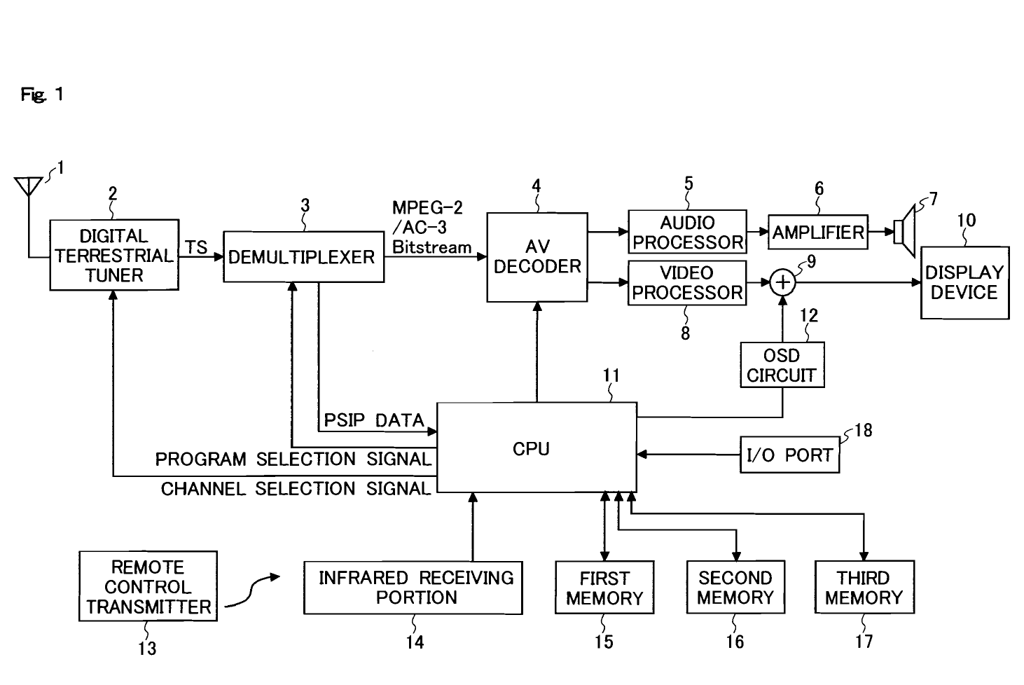

FIG. 1 is a block diagram of a television set 100 according to the embodiment of the invention. In this embodiment, the embodiment will be described using a U.S. digital television set that receives ATSC (advanced television systems committee) signals.

A terrestrial antenna 1 receives a digital terrestrial broadcast wave and feeds a received signal to a digital terrestrial tuner 2. The digital terrestrial tuner 2 receives a channel selection signal from a CPU (central processing unit) 11 to select a physical channel. Instead of the CPU, a microprocessor may be used. With this channel selection process, the digital terrestrial tuner 2 converts, into a signal of a specific frequency, a high-frequency 8VSB (8-level vestigial sideband) modulation signal containing video/audio data. The digital terrestrial tuner 2 includes an 8VSB demodulation circuit and the like that demodulate a digital modulation signal through the selected physical channel, and outputs a transport stream TS.

A demultiplexer (DEMUX) 3 divides the transport stream TS received from the digital terrestrial tuner 2 into predetermined packets, namely, a video stream of MPEG-2, an audio stream of AC-3 (“AC-3” refers to a registered trademark by “Dolby Laboratories Licensing Corporation”) and PSIP (program and system information protocol) data. The demultiplexer 3 receives a program selection signal from the CPU 11. The demultiplexer 3 feeds the video stream and the audio stream to an AV (audio video) decoder 4, and feeds the PSIP data including program information to the CPU 11.

The CPU 11 not only processes the PSIP data but also performs various controls on the television set 100 and processes a remote control signal that will be described later. A first memory 15, a second memory 16, a third memory 17 and an I/O port 18 are connected to the CPU 11. The first memory 15 is a RAM (random access memory) with which the CPU 11 performs operations. The second memory 16 is a flash memory that stores a program code. The third memory 17 is an EEPROM (electrically erasable and programmable read only memory) that stores a lock release code and that stores, once a proper lock release code is input from an input device, a lock release flag. The I/O port 18 is a port through which an electrical signal is input externally to the CPU 11 and through which an electrical signal is output externally from the CPU 11.

A plurality of virtual channels are multiplexed into the transport stream TS. A VCT (virtual channel table) is collected from the transport stream TS and then a predetermined packet ID is checked by reference to the VCT collected, and this allows any one of the virtual channels to be selected.

The AV decoder 4 is provided with an MPEG video decoder (not shown) that decodes an MPEG-2 bit stream and an AC-3 decoder (not shown) that decodes the audio stream (AC-3 bit stream). Video data produced by the MPEG video decoder in the AV decoder 4 is output to a video processor 8; audio data is output to an audio processor 5.

The video processor 8 receives the video data from the AV decoder 4 and performs D/A conversion to produce an analog video signal. The audio processor 5 receives the audio data from the AV decoder 4 and performs D/A conversion to produce an analog audio signal.

An OSD (on screen display) circuit 12 outputs a video signal to an adder 9 based on character information indicated by an output from the CPU 11. The adder 9 adds a video signal based on bitmap data and the video signal received from the OSD circuit 12, and feeds the resulting video signal to a display device (for example, a thin display device) 10.

The display device 10 displays video according to the video signal fed from the video processor 8. The analog audio signal from the audio processor 5 is amplified by an amplifier 6, and then a speaker 7 outputs the corresponding sound.

A remote control transmitter 13 is a transmitter that transmits various instructions to the television set. When input keys (not shown in FIG. 1) provided in the remote control transmitter 13 are operated, an infrared signal (remote control signal) serving as an instruction corresponding to input of the input keys is transmitted from a light emission portion (not shown). An infrared receiving portion 14 receives the infrared signal, converts the infrared signal into an electrical signal and feeds the electrical signal to the CPU 11.

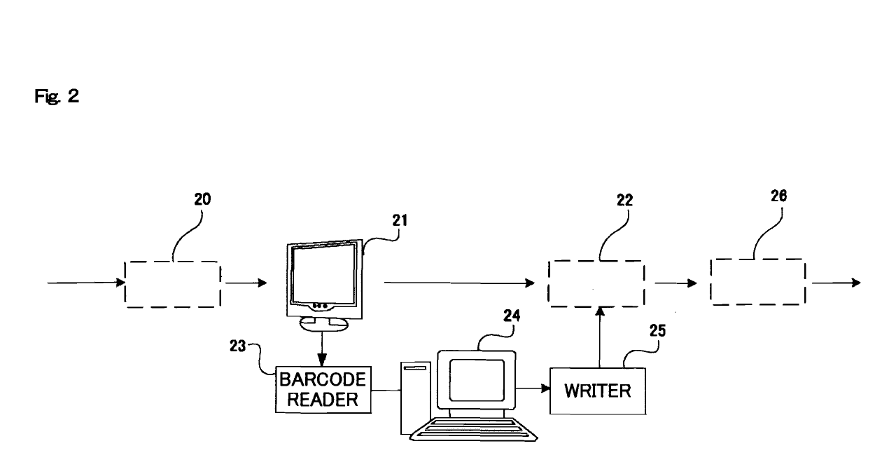

FIG. 2 is a diagram showing part of the manufacturing process of the television set shown in FIG. 1. An individual identification number (for example, a serial number) is given to each television set manufactured in a factory. The individual identification number (for example, a serial number) is given by attaching a barcode showing the individual identification number (for example, a serial number) to the main body of the television set. A code such as a two-dimensional code other than a barcode may be used instead of a barcode.

In this embodiment, a unique individual identification number (for example, a serial number) that is given to each television set in a manufacturing process 20 is stored in the third memory 17, and the same individual identification number (for example, a serial number) is also stored in the second memory 16.

As shown in FIG. 2, the television set that has completed predetermined steps in the manufacturing process 20 is transferred to the following manufacturing process 21. In the manufacturing process 21, the barcode showing the individual identification number (for example, a serial number) attached to the television set is read by a barcode reader 23. Then, the individual identification number (for example, a serial number) is input to a PC (personal computer) 24. The PC 24 has software that produces a lock release code unique to each individual identification number (for example, a serial number). The PC 24 produces the lock release code with the software. The lock release code thus produced is transferred to a writer 25.

In a manufacturing process 22, the lock release code is written, by the writer 25, in the third memory 17 in the television set. This writer 25 may be a remote control transmission portion that transmits, as an infrared remote control signal, a signal carrying the lock release code received from the PC 24. The lock release code transmitted from the writer 25 is received by the infrared receiving portion 14 of the television set, and is stored in the third memory 17 through the CPU 11 (see FIG. 1). The television set that stores the lock release code is delivered as a product (process 26).

In this way, one lock release code corresponding to one individual identification number is stored in the television set. Moreover, information corresponding to the lock release code is produced. The individual identification number (for example, a serial number), the information corresponding to the lock release code and the lock release code correspond to each other. The information corresponding to the lock release code and the lock release code are produced such that they agree with each other.

Any method for reading the individual identification number (for example, a serial number) may be employed. For example, an IIC (inter integrated circuit) bus may be used. In this case, the individual identification number (for example, a serial number) that is stored in the second memory 16 in the manufacturing process 20 is read through the IIC bus by the PC 24 in the manufacturing process 21.

The lock release code corresponding to the individual identification number (for example, a serial number) is produced by the PC 24, and the lock release code thus produced may be written through the IIC bus in the third memory 17 in the television set. The information used for the production of the lock release code is not limited to the individual identification number (for example, a serial number); any other type of information may be used instead. For example, the manufacturing date of the television set may be used. The method for producing the lock release code is not limited to that shown in FIG. 2; any other method may be used.

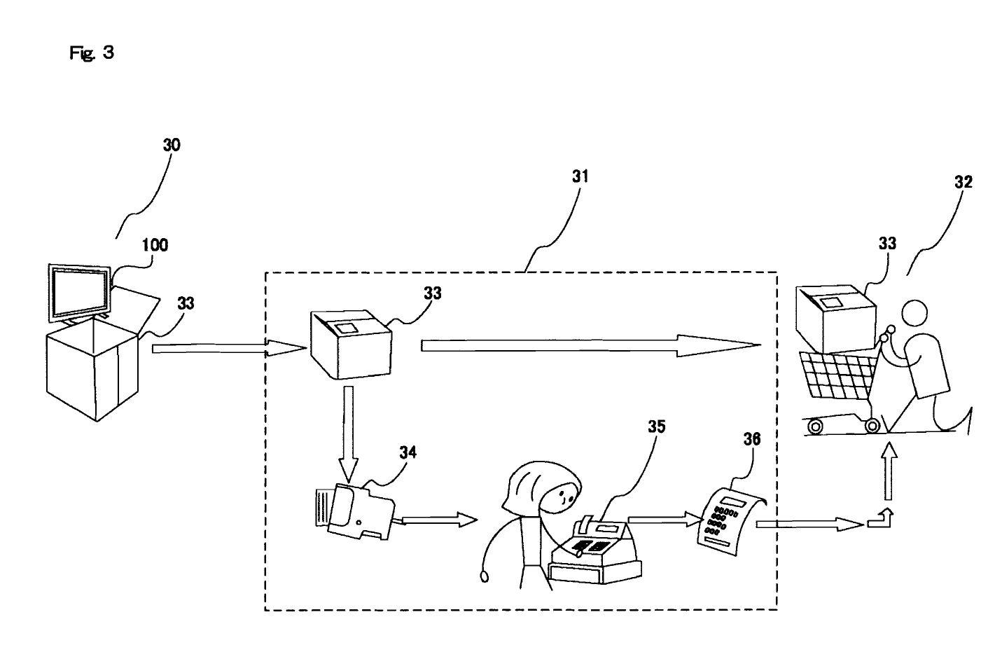

FIG. 3 is a diagram showing a procedure for issuing the information corresponding to the lock release code. In a manufacturing process 30, the television set 100 is packaged. In a sale process 31, the bar code showing the individual identification number (for example, a serial number) attached to the packaged television set 33 is read by a barcode reader 34. The read individual identification number (for example, a serial number) is imported into a register device 35. The register device 35 can obtain the information corresponding to the lock release code from each individual identification number (for example, a serial number). The obtained information corresponding to the lock release code is printed on a receipt 36 that shows the record of purchase, and the receipt 36 is handed over to a purchaser (process 32).

It is not always necessary to print the information corresponding to the lock release code on a receipt; any other method for giving it to the purchaser may be used. For example, it may be printed on a sheet that is separate from a receipt. The method for reading the individual identification number (for example, a serial number) is not limited to the method for reading it with a barcode reader; any other method for transferring the information to the register device may be used. For example, the individual identification number (for example, a serial number) may be directly input by a store clerk to the register device. Instead of transferring the individual identification number (for example, a serial number) to the register device, the information corresponding to the lock release code may be obtained by transferring the individual identification number (for example, a serial number) to another device. The timing at which the information corresponding to the lock release code is obtained is not limited.

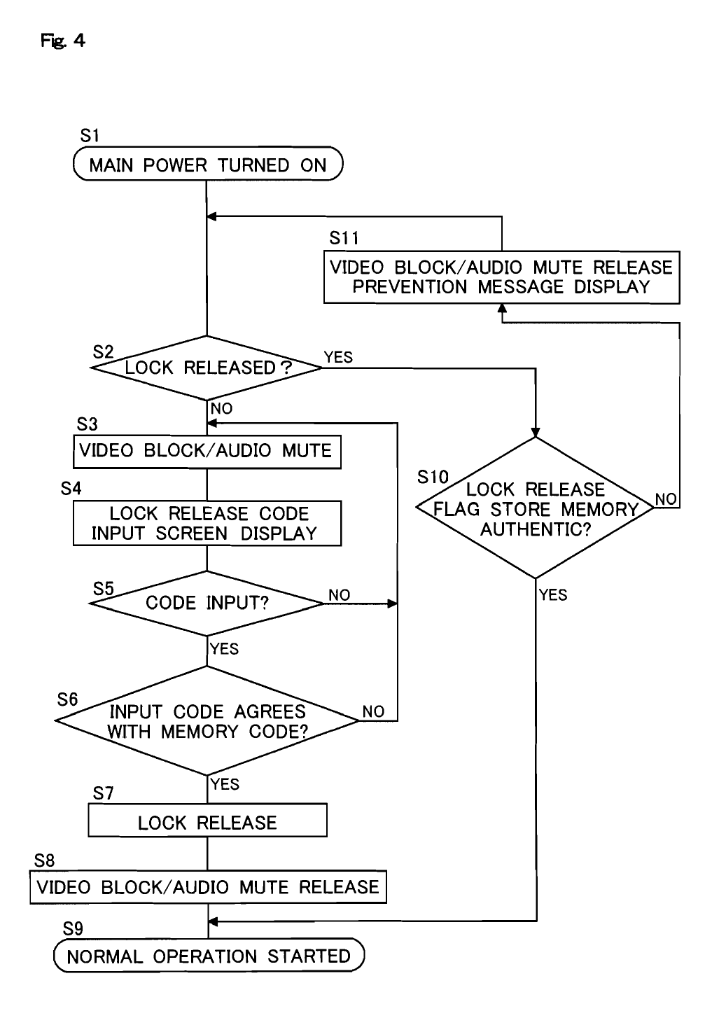

FIG. 4 is a diagram showing an example of a flow chart on how the television set shown in FIG. 1 is operated. The power to the television set is first turned on (step S1), and the CPU 11 in the television set checks whether or not a lock such as a video lock is released based on a lock release flag stored in the third memory 17 (step S2). If the lock such as a video lock is found to be already released, the process proceeds to step S10, which will be described later. On the other hand, if the lock such as a video lock is found not to be released yet, the video is blocked and the audio is muted (step S3).

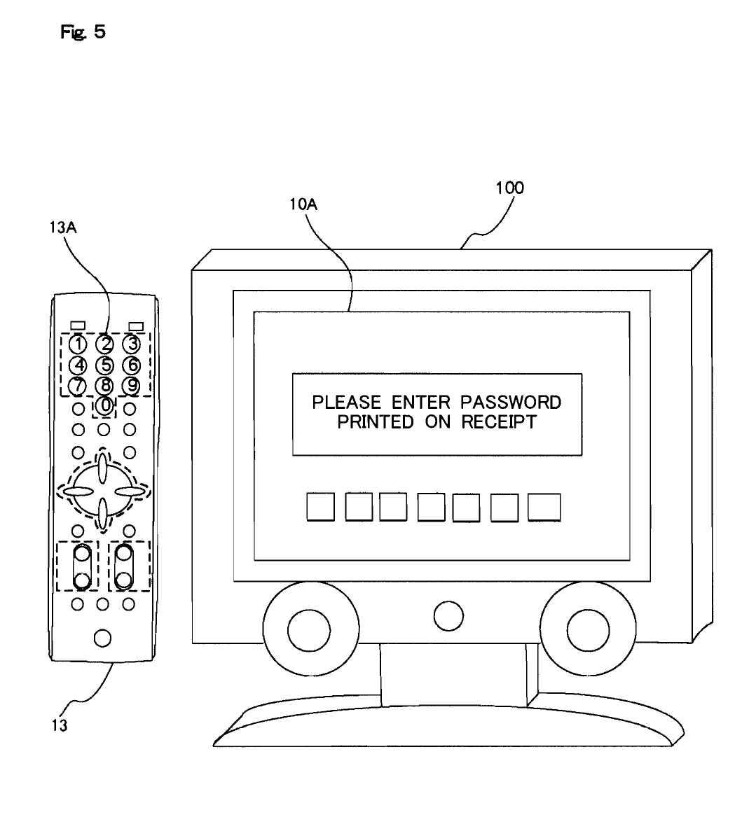

Thereafter, for example, a display for requesting the input of the information corresponding to the lock release code is displayed on the television set as shown in FIG. 5 (step S4). According to this instruction, a user inputs the information corresponding to the lock release code with a remote controller or the like. Here, the television set checks whether or not an input by the user is present (step S5). If no input is found, the video is blocked and the audio is muted (step S3).

On the other hand, if an input is found, the comparison portion of the television set checks whether or not the input information agrees with the lock release code stored in the third memory 17 (step S6). In this embodiment, the CPU 11 in the television set serves as the comparison portion of the television set.

If the input information is found to agree with the lock release code, the video lock and the audio lock are released (step S7). When the locks are released, the blocking of the video and the muting of the audio are released (step S8), and then the television set starts a channel selection preset operation, a video display and an audio output (step S9).

On the other hand, if the input information is found not to agree with the lock release code, the video is blocked and the audio is muted (step S3).

As described above, if, in step S2, the lock is found by the CPU 11 in the television set to be already released, the process proceeds to step S10. In step S10, the CPU 11 in the television set checks whether or not the third memory 17 storing the lock release flag is authentic. Here, if the individual identification number (for example, a serial number) is stored in the third memory 17, and the individual identification number (for example, a serial number) stored in the third memory 17 and the individual identification number (for example, a serial number) stored in the second memory 16 agree with each other, the third memory 17 is considered to be authentic, whereas, if this is not the case, the third memory 17 is considered not to be authentic.

If the third memory 17 storing the lock release flag is found to be authentic, the television set starts the channel selection preset operation, the video display and the audio output (step S9).

On the other hand, if the third memory 17 storing the lock release flag is found not to be authentic, a display showing that the blocking of the video and the muting of the audio cannot be released is displayed on the screen of the television set (step S11), and thereafter the process returns to step S2 and loops from step S2 to step S10 to step S11 and then back to step 2 until the power is turned off, with the result that a normal operation can be prevented from being started. Thus, the television set 100 of the present invention has the function of preventing the following act: a person who acquires a television set in an unauthorized manner copies data including a lock release flag stored in a lock release flag store memory in a television set that is purchased in an authorized manner and in which the lock is released, writes the copied data in a lock release flag store memory in the television set that is acquired in an unauthorized manner and in which the lock is not released and thereby makes the television set acquired in an unauthorized manner operate normally. In this way, the television set 100 of the present invention can achieve excellent anti-theft effects.

FIG. 5 is a diagram showing an example of the screen of the television set that requests the input of the information corresponding to the lock release code. FIG. 5 shows the television set 100 and the remote control transmitter 13, which is an example of a remote controller. The remote control transmitter 13 has a large number of input keys 13A. The television set 100 has a display screen 10A. The display screen 10A displays a display that says “please enter a password that is printed on the receipt”.

According to the instructions on the display screen 10A, the user enters, with the remote control transmitter 13, the information corresponding to the lock release code. If the entered information agrees with the lock release code stored in the third memory 17 in the television set 100, the video is displayed on the display screen 10A. On the other hand, if the entered information does not agree with the lock release code, the television set 100 enters a state where no video is displayed and no audio is output. The many input keys 13A include a key for correcting the input, a key for resetting the television set 100 to the initial state and an approval key for approving preset items.

The means for inputting the information is not particularly limited to the above-described example; any other means may be used. For example, instead of the remote controller, input keys provided in the television set may be used. Any type of display screen that requires the user to input information may be used. For example, when there are many numbers that need to be input, the display screen shows a few numbers (for example, three numbers) for each of the many numbers that need to be input, and then an input screen for the few numbers is displayed. Moreover, the numbers may be displayed on the display screen; the user may touch portions of the display where the numbers are present to select appropriate numbers. A column in which a symbol or a simple picture is drawn may be displayed on the display screen so that the user draws information in the column.

The timing at which the television set requires the input of information is not limited. For example, it may be done when the power to the television set is turned on or it may be done a few seconds after the power is turned on. By inputting many numbers and then using the approval key, the input may be approved as the information. In this case, if the approval key is pressed before completion of the input of all numbers that need to be input, a screen for use in continuous input may be displayed without the display screen being changed.

Instead of the individual identification number (for example, a serial number), the second memory 16 may store a code (for example, a code that is composed of the last two digits of the serial number) that can be uniquely derived from the individual identification number (for example, a serial number). In this case, if the individual identification number (for example, a serial number) is stored in the third memory 17, and the code (for example, a code that is composed of the last two digits of the serial number) that can be uniquely derived from the individual identification number (for example, a serial number) stored in the third memory 17 and the code stored in the second memory 16 agree with each other, the third memory 17 is considered to be authentic, whereas, if this is not the case, the third memory is considered not to be authentic.

Instead of the individual identification number (for example, a serial number) being stored in the second memory 16, the code (for example, a code that is composed of the last two digits of the serial number) that can be uniquely derived from the individual identification number (for example, a serial number) may be set at the I/O port 18. For example, the setting of the I/O port 18 can be achieved as follows: the code is expressed in binary code, “1” and “0” expressed in binary code are replaced by electrical signals “H” and “L”, respectively, the bit of the I/O port 18 through which the electrical signal “H” needs to be input is connected to a high potential and the bit of the I/O port 18 through which the electrical signal “L” needs to be input is connected to a low potential. In this case, if the individual identification number (for example, a serial number) is stored in the third memory 17, and the code (for example, a code that is composed of the last two digits of the serial number) that can be uniquely derived from the individual identification number (for example, a serial number) stored in the third memory 17 and the code set at the I/O port 18 agree with each other, the third memory 17 is considered to be authentic, whereas, if this is not the case, the third memory 17 is considered not to be authentic. By setting the code at the I/O port 18 in this way, even if not only the third memory 17 but also the second memory 16 are copied illegally, it is possible to prevent the lock from being illegally released.

The present invention is not limited to the embodiment described above. For example, although the television set is only described with reference to FIGS. 1 to 5, the description of FIGS. 1 to 5 can apply to any electronic devices such as VCRs (video cassette recorder), DVD (digital versatile disc) players, camcorders, vacuum cleaners, electrical heaters, air-conditioning machines, rice cookers, digital cameras, fixed-line telephones, mobile telephones, personal computers and electrical fans. The lock release flag and the lock release code may be stored in separate memories. The electronic devices may be provided with a solar battery.

What is claimed is:

1. An electronic device comprising:
a first lock release code store memory including a first lock release code;
a lock release flag store memory including a lock release flag that shows whether or not a lock is released;
a comparison portion comparing the first lock release code with a second lock release code input by an input device;
a control portion releasing, when the comparison by the comparison portion results in agreement, the lock to permit the electronic device to operate normally; and
a determination portion determining whether or not the lock release flag store memory is authentic.

2. The electronic device of claim 1,
wherein, even when the lock release flag shows that the lock is released, if the determination portion determines that the lock release flag memory is not authentic, the electronic device is not permitted to operate normally.

3. The electronic device of claim 1,
wherein the lock release flag store memory and one or more memories other than the lock release flag store memory individually store a unique individual identification number given to each of electronic devices, and the determination portion determines that the lock release flag store memory is authentic if the individual identification number is stored in the lock release flag store memory and the individual identification number stored in the lock release flag store memory and the individual identification number stored in the one or more memories other than the lock release flag store memory agree with each other.

4. The electronic device of claim 1,
wherein the lock release flag store memory stores a unique individual identification number given to each of electronic devices, one or more memories other than the lock release flag store memory store a code corresponding to the individual identification number stored in the lock release flag store memory and the determination portion determines that the lock release flag store memory is authentic if the individual identification number is stored in the lock release flag store memory and the code corresponding to the individual identification number stored in the lock release flag store memory and the code stored in the one or more memories other than the lock release flag store memory agree with each other.

5. The electronic device of claim 1, further comprising:
a port,
wherein the lock release flag store memory stores a unique individual identification number given to each of electronic devices, the port sets a code corresponding to the individual identification number stored in the lock release flag store memory and the determination portion determines that the lock release flag store memory is authentic if the individual identification number is stored in the lock release flag store memory and the code corresponding to the individual identification number stored in the lock release flag store memory and the code set by the port agree with each other.

6. The electronic device of claim 1,
wherein the electronic device is a television set.

7. A method of preventing an electronic device from being stolen, the method comprising the steps of:
storing a lock release code in a lock release code store memory included in the electronic device;
producing information corresponding to the lock release code;
making the electronic device request input of the information corresponding to the lock release code;
comparing the input information with the lock release code stored in the lock release code store memory;
making, when the input information is found to agree with the lock release code stored in the lock release code store memory, a lock release flag that is stored in a lock release flag store memory in the electronic device and that shows whether or not a lock is released show that the lock is released, and thus permitting the electronic device to operate normally; and
determining whether or not the lock release flag memory is authentic.

8. The method of preventing an electronic device from being stolen according to claim 7,
wherein, even when the lock release flag shows that the lock is released, if, in the step of determining whether or not the lock release flag memory is authentic, it is determined that the lock release flag memory is not authentic, the electronic device is not permitted to operate normally.

9. The method of preventing an electronic device from being stolen according to claim 7,
wherein the lock release flag store memory and one or more memories other than the lock release flag store memory individually store a unique individual identification number given to each of electronic devices, and, in the step of determining whether or not the lock release flag memory is authentic, it is determined that the lock release flag store memory is authentic if the individual identification number is stored in the lock release flag store memory and the individual identification number stored in the lock release flag store memory and the individual identification number stored in the one or more memories other than the lock release flag store memory agree with each other.

10. The method of preventing an electronic device from being stolen according to claim 7,
wherein the lock release flag store memory stores a unique individual identification number given to each of electronic devices, one or more memories other than the lock release flag store memory store a code corresponding to the individual identification number stored in the lock release flag store memory and, in the step of determining whether or not the lock release flag memory is authentic, it is determined that the lock release flag store memory is authentic if the individual identification number is stored in the lock release flag store memory and the code corresponding to the individual identification number stored in the lock release flag store memory and the code stored in the one or more memories other than the lock release flag store memory agree with each other.

11. The method of preventing an electronic device from being stolen according to claim 7,
wherein the electronic device comprises a port, the lock release flag store memory stores a unique individual identification number given to each of electronic devices, the port sets a code corresponding to the individual identification number stored in the lock release flag store memory and, in the step of determining whether or not the lock release flag memory is authentic, it is determined that the lock release flag store memory is authentic if the individual identification number is stored in the lock release flag store memory and the code corresponding to the individual identification number stored in the lock release flag store memory and the code set by the port agree with each other.

12. The method of preventing an electronic device from being stolen according to claim 7,
wherein the electronic device is a television set.
